(19) United States
(12) Patent Application Publication
(10) Pub. No.: US 2004/0017585 A1
(43) Pub. Date: Jan. 29, 2004

(54) Output supporting server, output supporting method, and output supporting system

(75) Inventors: Shinji Makishima, Shizuoka-ken (JP); Kazuhiro Ogura, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/206,359

(22) Filed: Jul. 29, 2002

(51) Int. Cl. B41F 1/00; G06K 1/00; G06F 15/00

(52) U.S. Cl. 358/1.18; 358/1.13

(57) ABSTRACT

An output supporting server supports various outputs generated by a client terminal via a network circuit. The server includes: a template storage unit for storing a template to be output, the template specifying a standard configuration of output data to be generated by the client terminal; a template response unit for reading the output template from the template storage unit in response to a request from the client terminal and then sending the template to the client terminal; and an output data creation unit for creating the output data after the template is sent by the template response unit, in accordance with a configuration changing operation performed at the client terminal, the operation being performed on the output template received by the client terminal via the network, and then transmitting the output data to the client terminal in order to permit the client terminal to generate the output data.

### BACKGROUND OF THE INVENTION

1. Field of the Invention

The present invention relates to an output supporting system which is applied to a case where various outputs for display, printing, and the like are generated by a client terminal on the basis of a prepared template.

The present invention also relates to an output supporting server and an output supporting method.

2. Description of the Related Art

In recent years, the use of services whereby various operations can be performed using a hypertext system on the Internet has increased. Japanese Unexamined Patent Application No. 2000-284937 (P2000-284937A) (Document 1) discloses a conventional system of this kind.

According to the system described in Document 1, a Web server on the Internet receives information which a user inputs through a Web browser on a client terminal, edits print data on the basis of this information, and then prints out the data. If required, the print data edited by the Web server can be sent to the Web browser and then printed out at the client terminal.

Generally, in the operation services using the hypertext system, in many cases, several client terminals simultaneously access the Web server. Therefore, the load on the processing capability of the Web server is large. Furthermore, in order to provide a convenient operation service, it is necessary to sufficiently reduce the time (response time) required until a response regarding the operation performed on the Web browser by the user is sent from the Web server to the Web browser.

### SUMMARY OF THE INVENTION

In consideration of the above problems, it is an object of the present invention to provide a method for efficiently realizing a reduction in load on an output supporting server (for example, a Web server).

According to the present invention, there is provided an output supporting server for supporting various outputs performed in a client terminal via a network, the server including: a template storage unit for storing a template to be output, the template specifying a standard configuration of output data to be generated by the client terminal; a template response unit for reading the output template from the template storage unit in response to a request from the client terminal and then sending the output template to the client terminal; and an output data creation unit for creating output data in accordance with a configuration changing operation performed at the client terminal, the operation being performed on the output template received by the client terminal via the network, and then transmitting the created output data to the client terminal in order to permit the client terminal to generate the output data.

### BRIEF DESCRIPTION OF THE DRAWINGS

FIG. 1 is a schematic diagram showing an example of the configuration of a Web server according to an embodiment of the present invention;

FIG. 2 is a schematic diagram showing an example of the configuration of a communication terminal according to the present embodiment of the present invention;

FIG. 3 is a schematic diagram showing an example of the entire configuration of a communication system according to the embodiment of the present invention;

FIG. 4 is a flowchart showing the operation according to the embodiment of the present invention;

FIG. 5 is a flowchart showing the operation according to the embodiment of the present invention;

FIG. 6 is a flowchart showing the operation according to the embodiment of the present invention;

FIG. 7 is a flowchart showing the operation according to the embodiment of the present invention;

FIG. 8 is a schematic view of the configuration of a table used in the embodiment of the present invention as an example;

FIG. 9 is a schematic view of the configuration of a table used in the embodiment of the present invention as an example;

FIG. 10 is a schematic view of the configuration of a table used in the embodiment of the present invention as an example;

FIG. 11 is a schematic view of a screen layout of a operation supporting template used in the embodiment of the present invention as an example; and

FIG. 12 is a schematic view of a log-in screen layout used in the embodiment of the present invention as an example.

### DESCRIPTION OF THE PREFERRED EMBODIMENT

A preferred embodiment of the present invention will now be described hereinbelow with reference to the accompanying drawings.

FIG. 3 illustrates an example of the whole configuration of a communication system 10 according to the present embodiment.

Referring to FIG. 3, the communication system 10 comprises a network 11, a Web server 12, communication terminals 13 and 14, and printers 15 and 16.

The network 11 connects the Web server 12 to each communication terminal (13 or 14). A LAN (local area network) can be used as the network 11. In this case, it is assumed that the network 11 is the Internet.

The communication terminals 13 and 14 function as information processors for communicating with the Web server 12 via the network 11. Specifically, personal computers having a network function may be used. It is assumed that a user U1 uses the communication terminal 13 and a user U2 uses the communication terminal 14.

The printer (for example, 15) has a function to execute a print output in response to a request sent from the communication terminal (for example, 13) connected to the present printer.

The printers such as the printers 15 and 16 are broadly divided into two types. One type of printer has fonts (printer fonts) therein independently of the communication terminal (13 or 14). The printer fonts are stored in a ROM or the like. Another type of printer does not have a printer font therein.

In the printer which does not have any printer fonts therein, print output for text and print output for image are generally processed without being distinguished from each other. In the printer having printer fonts therein, print output for text is processed on the basis of the printer font and the process is executed in a manner different from that for print output for image. Principally, the printer fonts need not match the fonts (screen fonts) stored in the communication terminal.

A font can be uniquely identified using a font name assigned to a file (font file) in which the font is stored.

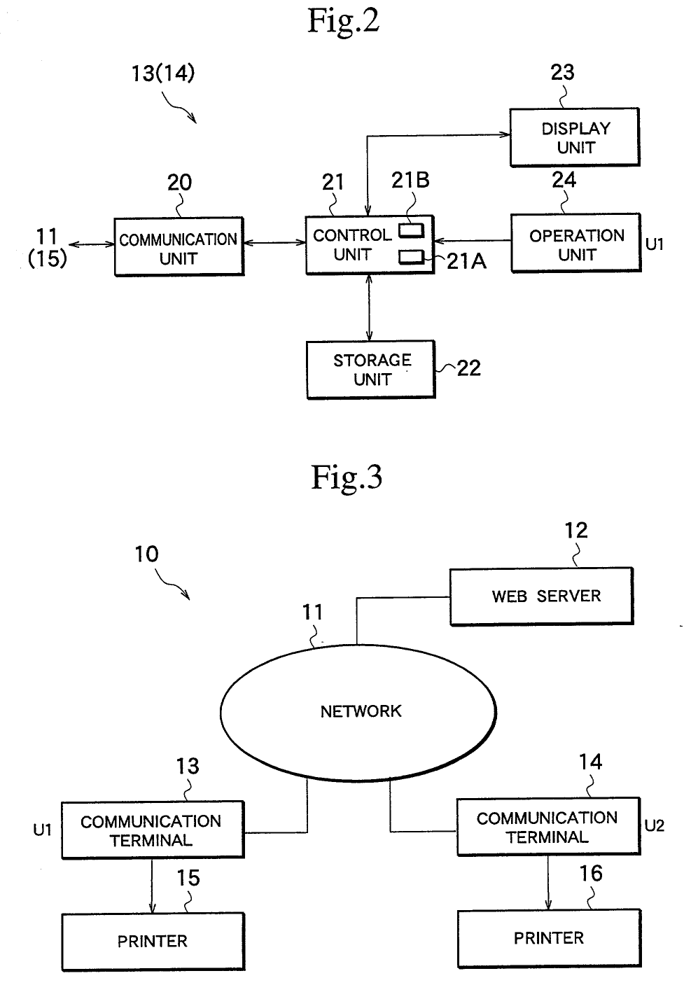

The internal configuration of each of the communication terminals 13 and 14 may be, for example, as shown in FIG. 2.

Referring to FIG. 2, the communication terminal 13 comprises a communication unit 20, a control unit 21, a storage unit 22, a display unit 23, and an operation unit 24.

The communication unit 20 has a function necessary to communicate with the Web server 12 via the network 11 and further has a function to communicate with the printer 15. In order to communicate with the Web server 12 via the Internet 11, the communication unit 20 must perform IP-based (Internet Protocol) communication in the network layer of the OSI reference model, TCP-based (Transmission Control Protocol) communication in the transport layer, and HTTP-based (Hypertext Transfer Protocol) communication in the presentation layer and the application layer. Accordingly, modules for communicating according to these protocols are provided in the communication unit 20.

The control unit 21 corresponds to both a central processing unit (CPU) and an operating system (OS (which is designated by reference numeral 21B)) of the communication terminal 13.

According to the present embodiment, the communication terminal 13 has a Web browser 21A serving as a program for browsing Web pages. The Web browser 21A also corresponds to the control unit 21. The Web browser 21A is one of many applications which can be installed in the communication terminal 13, the applications being under the control of the OS 21B.

The storage unit 22 is a storage device managed by the control unit 21. If the communication terminal 13 is a normal personal computer, the storage unit 22 includes a volatile storage device (such as a RAM) and a nonvolatile storage device (such as a hard disk).

The display unit 23 displays a screen to the user U1. For example, when the user U1 views a Web page presented by the Web server 12 using the Web browser 21A, the content of the Web page is formatted by the Web browser 21A and is then displayed on a screen of the display unit 23.

The operation unit 24 accepts an operation which the user U1 performs on the communication terminal 13. If the communication terminal 13 is a normal personal computer, the operation unit 24 includes a pointing device such as a mouse or a trackball, and a keyboard.

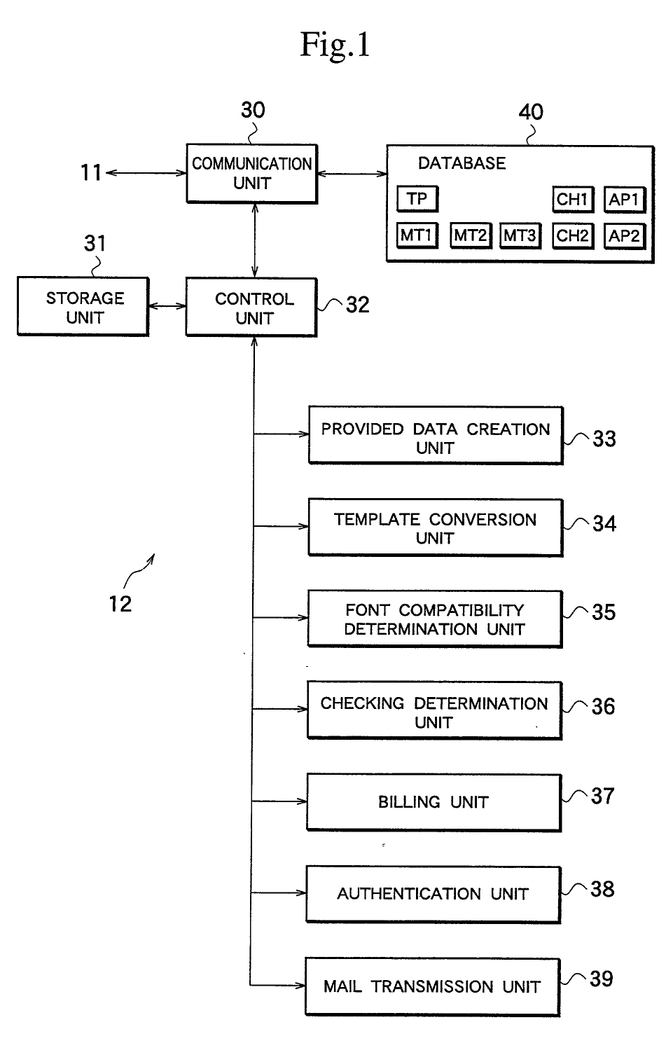

For the internal configuration of the Web server 12 which communicates with the communication terminals 13 and 14, each having the above configuration, via the network 11, for example, the configuration shown in FIG. 1 can be used. When the communication terminal 13 accesses the network, the Web server 12 has a function to communicate with a database 40 at the same Web site and to send Web pages (including a operation supporting template TP) to the communication terminal 13.

Upon creation of a normal Web page, a font should not be designated. The reason is that, if the user designates a font on the Web page, if that font is not installed in the Web browser, unexpected display is caused. According to the present embodiment, it is necessary to designate a font on a Web page (particularly, an operation supporting template) provided by the Web server 12 from the viewpoint of the characteristics of the Web page.

Referring to FIG. 1, the Web server 12 comprises a communication unit 30, a storage unit 31, a control unit 32, a provided data creation unit 33, a template conversion unit 34, a font compatibility determination unit 35, a checking determination unit 36, a billing unit 37, an authentication unit 38, and a mail transmission unit 39.

The communication unit 30 communicates with the communication unit 20 of the communication terminal 13 via the network 11. The communication unit 30 includes modules for communicating using IP, TCP, and HTTP. The communication unit 30 also has a function to communicate with the database 40. Ordinarily, the communication with the database (including a DBMS (data base management system)) 40 is performed according to a vendor-specific protocol.

The database 40 comprises a storage device such as a hard disk. For example, the database 40 is managed by a database management system such as an RDBMS (relational database management system) adapted to a relational model.

Various data, including data regarding management of the Web site and customer management (user management), are stored and managed in the database 40. An operation supporting template (for example, TP) and management tables MT1 to MT3 to manage the operation supporting template TP serve as data that is characteristic to the present embodiment. A file for storing data serving as the content of the operation supporting template can be stored in a folder. The management tables MT1 to MT3 can be managed by the RDBMS.

Each operation supporting template has a standard format compatible with various types of printed matters. The operation supporting template denotes data which facilitates the user's (for example, the user U1) operation of creating printed matter and obtaining the printed matter and which realizes a reduction in the processing load of the Web server 12 when outputting the printed matter. In a case where the user U1 edits printed matter without a specified format on the Web server 12, if the user U1 uses the operation supporting template, the load on the Web server 12 can be reduced though the flexibility of the editing operation is restricted.

A plurality of kinds of operation supporting templates are stored in the database 40. On the basis of information (e.g., a natural language and a URL) inputted into the Web browser 21A by the user U1 upon access, it is determined which operation supporting template is sent to the user U1.

For instance, when the user U1 inputs information (selective information) designating the operation supporting template TP for a flyer for a supermarket and then transmits an HTTP request, upon receiving the HTTP request, the Web server 12 sends the operation supporting template TP as an HTTP response to the communication terminal 13.

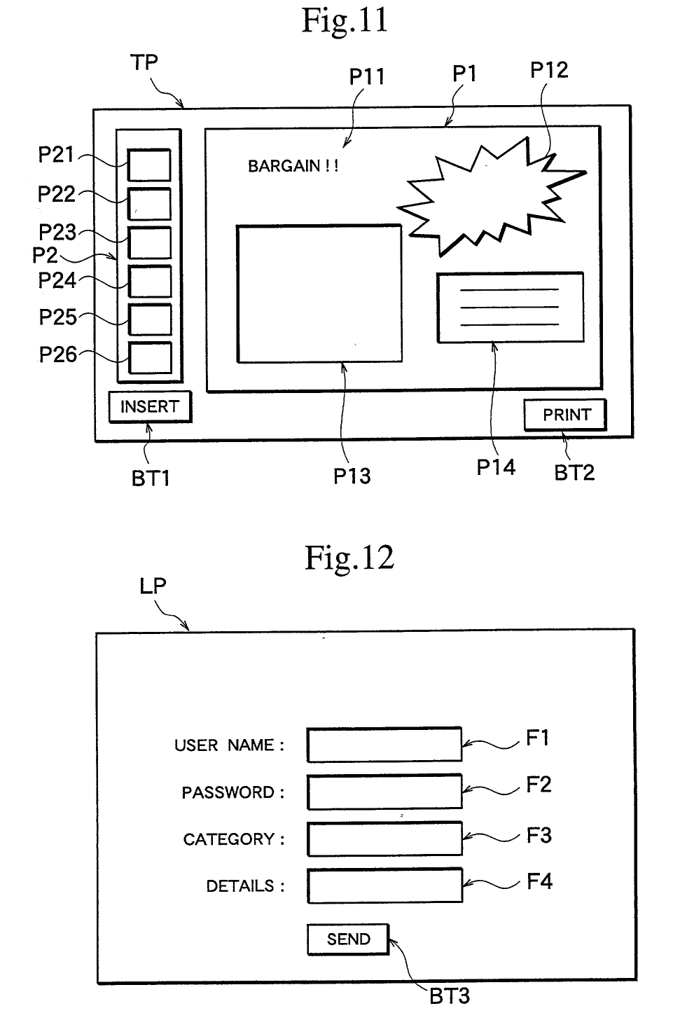

When the operation supporting template TP is received by the communication terminal 13 and is then processed by the Web browser 21A, a screen shown, for example, in FIG. 11 is displayed on the display unit 23 of the communication terminal 13. The user U1 performs the operation of editing a flyer using the screen.

Referring to FIG. 11, the operation supporting template TP has display elements P1 and P2 and buttons BT1 and BT2. The display elements P1 and P2 may be displayed as discrete documents on the same screen using a so-called frame function.

The display element P1 is the main area of the operation supporting template TP. In this area, the content of the flyer which will actually be printed is simulated.

For example, the display element P1 includes text P11 such as “Bargain!!”, which will serve as the title of the flyer, an image P12 such as a predetermined picture or design, an image area 13 where a selected image is placed, and a field P14.

In the field P14, the content to be given to supermarket customers, specifically, what kinds of products are on sale and the prices of the products, is described using a natural language. Therefore, the user U1 who inputs the selective information designating the operation supporting template TP is a person in charge of running the supermarket.

The display element P2 includes six images P21 to P26 having different contents.

The user U1, who views the images in the operation supporting template TP on the display unit 23 of the communication terminal 13, selects one image (for example, P23) of the six images P21 to P26 using the pointing device provided for the operation unit 24. When the user U1 presses the “insert” button BT1, the selected image P23 is enlarged and is then placed (inserted) in the image area P13.

Any of the images P21 to P26 can be selected and inserted by repeating the similar operation.

Some Web browsers have a function whereby the text font on a Web page can be changed. When the Web browser 21A is of this type, if necessary, the font of the text P11 can be changed in one of the editing operation steps.

Finally, the image to be placed in the image area P13 is determined, the content to be described in the field P14 is determined, and the editing operation is completed. Thus, the content of the flyer is fixed. After that, when the user U1 presses the “print” button BT2, a flyer having the same content as that of the display element P1 displayed on the display unit 23 at that time can be printed by the printer 15.

According to the present embodiment, after the operation supporting template TP is sent to the communication terminal 13, it is not necessary for the Web server 12 to be involved in the process of printing the flyer. Accordingly, the load on the processing capability of the Web server 12 is smaller than in the conventional case.

The control unit 32 of the Web server 12 shown in FIG. 1 corresponds to both a CPU and an OS of the Web server 12.

In a hypertext system, a session between the communication terminal 13 and the Web server 12 is terminated after every HTTP request and the corresponding HTTP response (in other words, each time a new Web page is displayed on the display unit 23). Therefore, the control unit 32 needs to manage sessions in order to identify a series of accesses (a series of HTTP requests) from each user (for example, U1) and then send responses (HTTP responses) consistent with the requests.

The storage unit 31 is a storage device managed by the control unit 32. In the same way as in the communication terminal 13, the Web server 12 generally has a volatile storage device (such as a RAM) and a nonvolatile storage device (such as a hard disk). Generally, the capacity of each storage device is larger than that of the communication terminal 13.

The components 33 to 39 connected to the control unit 32 are the features of the present embodiment.

Among the components 33 to 39, the checking determination unit 36 determines whether or not it is necessary to check font compatibility.

Font compatibility means the property of the Web browser (21A) of the communication terminal (for example, 13) which accesses the Web server 12. If there is font compatibility, an operation supporting template (for example, TP) including the font of the foregoing text P11, such as “Bargain!!”, can be faithfully output (displayed on a screen or printed out), when the template is provided as a Web page from the Web server 12.

When the accessing communication terminal is compatible with the font for text in the operation supporting template, the operation supporting template can be provided. However, in the case where the terminal is not compatible with the font, if the operation supporting template is provided unmodified, an output faithful to the font is not displayed on the screen or printed at the communication terminal 13.

In this case, the text P11, such as “Bargain!!”, mentioned above is not provided as text data with a certain font. Instead, the text P11 is provided as image data. Accordingly, it is necessary to perform a process of converting text data with a certain font into image data faithfully reproducing the shape and size of the font. The template conversion unit 34 executes this converting process.

When text data is converted into image data in a standard data format (such as JPEG (Joint Photographic Experts Group) or GIF (Graphic Interchange Format)) by the template conversion unit 34, the data can be displayed on a screen by almost any Web browser used on the Internet.

The reason why the checking determination unit 36 is provided is that when the operation supporting template is not limited to a flyer, that is, when it is assumed that the template is used as a general-purpose operation supporting template, a template having no text data with a certain font, such as “Bargain!!” mentioned above, may be used. In case of an operation supporting template having no text data with a certain font, determining font compatibility can be omitted.

In the Web server 12, the font compatibility determination unit 35 is related to the above determination regarding font compatibility.

In some cases, font compatibility can be determined merely by referring to the name of the Web browser and version information included in a header of the HTTP request. The reason is as follows. For example, when the name or version of the Web browser 21A is known, the name or version of the OS 21B can be guessed, so that fonts previously installed on the OS 21B can also be guessed. According to the present embodiment, in order to more precisely perform the determination in more detail, plug-in software (compatibility-check plug-in) CH1 and a compatibility-check applet AP1 may be used.

The compatibility-check plug-in CH1 is an independent program which is transmitted from the Web server 12 to the communication terminal 13 which accesses the Web server 12 via the network 11. The plug-in CH1 has a function to check for font compatibility and then transmit the check result to the Web server 12.

The compatibility-check applet AP1 is transmitted together with a Web page via the network 11 and then operates on the Web browser 21A. The applet AP1 has a function to check for font compatibility and then transmit the check result to the Web server 12.

Upon checking for font compatibility, the check target of the compatibility-check plug-in CH1 or the compatibility-check applet AP1 is determined depending on the mechanism for font management of the communication terminal 13.

For example, it is assumed that the OS 21B included in the control unit 21 of the communication terminal 13 uniquely manages all font files in a specific folder (font folder) and the font files in the font folder are shared by applications such as the Web browser 21A and the like. In case of this type of font management, the font name of each font file stored in the font folder can serve as the check target.

When settings of the Web browser 21A affect the font displayed on the screen of the display unit 23 through the Web browser 21A, the settings of the Web browser 21A can also serve as the check target.

Further, when the type of the printer 15 is the above-mentioned type in which printer fonts are installed, preferably, the printer fonts are set as the check target.

When it is difficult for the compatibility-check plug-in CH1 or the compatibility-check applet AP1 to directly check the printer fonts installed on the printer 15, a printer driver, which is stored in the communication terminal 13 in order to drive the printer 15, is checked. Thus, the printer driver may be checked instead of the printer fonts.

In a case where the printer 15 is of the type in which printer fonts are not installed, if the communication terminal 13 is a WYSIWYG type information processor, there is no substantial difference between a screen display font displayed by the display unit 23 and a printer font printed by the printer 15 (a difference between a bitmapped font and an outline font may occur due to a difference between the screen display resolution and the print resolution). Therefore, in this case, a separate check for the printer fonts is not needed.

The function of the compatibility-check applet AP1 is limited for security reasons. However, the function of the compatibility-check plug-in CH1 is not limited. Accordingly, the compatibility-check plug-in CH1 can be designed so as to execute various processes which can be executed by normal middleware (for example, processes including access to hardware (the storage unit 22)) in the communication terminal 13. Therefore, it can be said that the checking capability of the compatibility-check plug-in CH1 is generally higher than that of the compatibility-check applet AP1.

Preparing both the compatibility-check plug-in CH1 and the compatibility-check applet AP1 on the Web server 12 is possible. Alternatively, preparing any of them is also possible. In the case where only the compatibility-check plug-in CH1 is prepared, if installation of the plug-in CH1 is rejected by the user U1, the check cannot be supported. Accordingly, at least the compatibility-check applet AP1 should be prepared.

The following case can also be implemented: The compatibility-check plug-in CH1 or the compatibility-check applet AP1 does not check for font compatibility but instead collects information (basic information) necessary for checking from the communication terminal 13 and then transmits the information to the Web server 12. Then, the font compatibility determination unit 35 performs checking for font compatibility using this basic information. According to the embodiment, however, the compatibility-check plug-in CH1 or the compatibility-check applet AP1 performs checking for font compatibility at the communication terminal 13. The reason is that executing as many processes as possible in the communication terminal 13 reduces the load on the Web server 12.

According to the present embodiment, therefore, it is sufficient if the font compatibility determination unit 35 has a function to interpret the check result transmitted from the compatibility-check plug-in CH1 or the compatibility-check applet AP1 and to permit the template conversion unit 34 or the provided data creation unit 33 to operate in accordance with the interpretation result.

The provided data creation unit 33 creates a Web page to be provided to the user (for example, U1). For instance, when the operation supporting template (e.g., TP) is transmitted to the communication terminal (e.g., 13), the provided data creation unit 33 reconfigures and creates the operation supporting template as necessary.

For example, in the case where the display elements P1 and P2 are independently managed in the database 40, the provided data creation unit 33 combines the display elements P1 and P2 in accordance with the selective information inputted by the user U1, thereby creating the operation supporting template TP.

The provided data creation unit 33 also reconfigures the operation supporting template on the basis of the result of the converting process performed by the template conversion unit 34 and then creates the operation supporting template to be provided to the user U1.

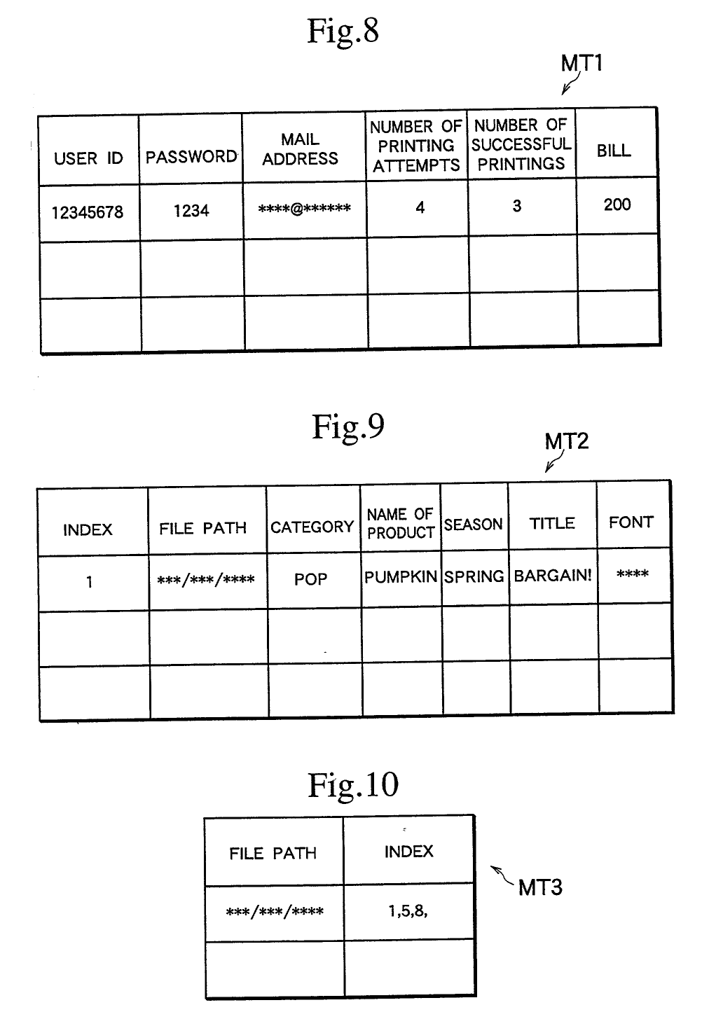

The billing unit 37 executes a billing process to the user U1. According to the present embodiment, it is assumed that the Web server 12 has a membership system and services are provided only to the users who have previously been registered as members. Upon member registration, a user ID and a password are given to each user. Referring to FIG. 8, a user ID and a password in the management table MT1 correspond to the user ID and the password, respectively.

Various billing systems may be used. In this case, a billing system for billing the user each time a print output based on a certain operation supporting template is performed is used. In this instance, when the print output is normally performed, billing has to be performed surely. On the other hand, when the print output is not normally performed, billing must not be performed.

As mentioned above, according to the present embodiment, a print output is executed at the communication terminal (for example, 13). Accordingly, the Web server 12 cannot directly confirm whether a print output was executed or, if a print output was performed, whether the print output was performed successfully (for example, accurately representing the font).

According to the present embodiment, therefore, plug-in software or an applet is also used for billing. The plug-in software for billing is set to billing-check plug-in CH2 and the applet for billing is set to a billing-check applet AP2.

Each of the billing-check plug-in CH2 and the billing-check applet AP2 has a function to check whether print out using the operation supporting template TP was normally performed at the communication terminal 13 and to transmit the check result to the Web server 12.

Regarding limits for security reasons and the checking capability, the billing-check plug-in CH2 has the same conditions as those of the compatibility-check plug-in CH1 and the billing-check applet AP2 has the same conditions as those of the compatibility-check applet AP1.

As necessary, the function of the plug-in CH2 may be integrated into the plug-in CH1 and the function of the applet AP2 may be integrated into the applet AP1. Integrating the plug-in CH2 with the plug-in CH1 can lighten the operating load on the user U1 because the number of times that the user's intention of installing the plug-in is confirmed. In both the case where the plug-in CH2 is integrated with the plug-in CH1 and the case where the applet AP2 is integrated with the applet AP1, the number of transmission times of the plug-in software or the applet from the Web server 12 is reduced. Accordingly, integrating effectively reduces the load. Furthermore, the integration is also effective from the viewpoint of reducing communication traffic.

When the above-mentioned enough short response time is realized, communication traffic may become a bottleneck. Accordingly, consideration must be given to reducing the communication traffic. In other words, the response time corresponds to the sum of the time required for communication in a transmission path and the time required for the process at the Web server 12. Accordingly, in a case where communication traffic is not enough low as compared with a communication band of the transmission path between the communication terminal 13 and the Web server 12, if the process executed by the Web server 12 is performed at high speed, the response time cannot be reduced.

When the billing-check plug-in CH2 and the billing-check applet AP2 (including the plug-in CH1 and the applet AP1) are transmitted to the communication terminal 13, the provided data creation unit 33 may operate. The billing unit 37 executes the billing process for the user U1 using the check result transmitted from the communication terminal 13 by the billing-check plug-in CH2 or the billing-check applet AP2.

The authentication unit 38 authenticates the user who accesses the Web server 12. User authentication is performed using the user ID or the password given to the user upon member registration.

The mail transmission unit 39 transmits an electronic mail to the user U1, the mail notifying the user of an amount of money which the user U1 has to pay, serving as the result of the billing process performed by the billing unit 37. An e-mail address of the user U1 serving as a destination of the e-mail can previously be obtained upon member registration. Referring to FIG. 8, a mail address in the management table MT1 corresponds to the e-mail address.

When the mail transmission unit 39 is provided in the Web server 12 as shown in FIG. 1, the e-mail can be sent using a mechanism for Web mails.

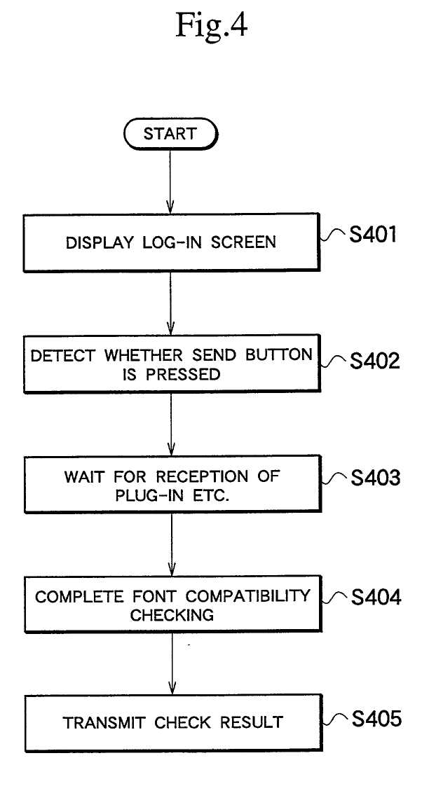

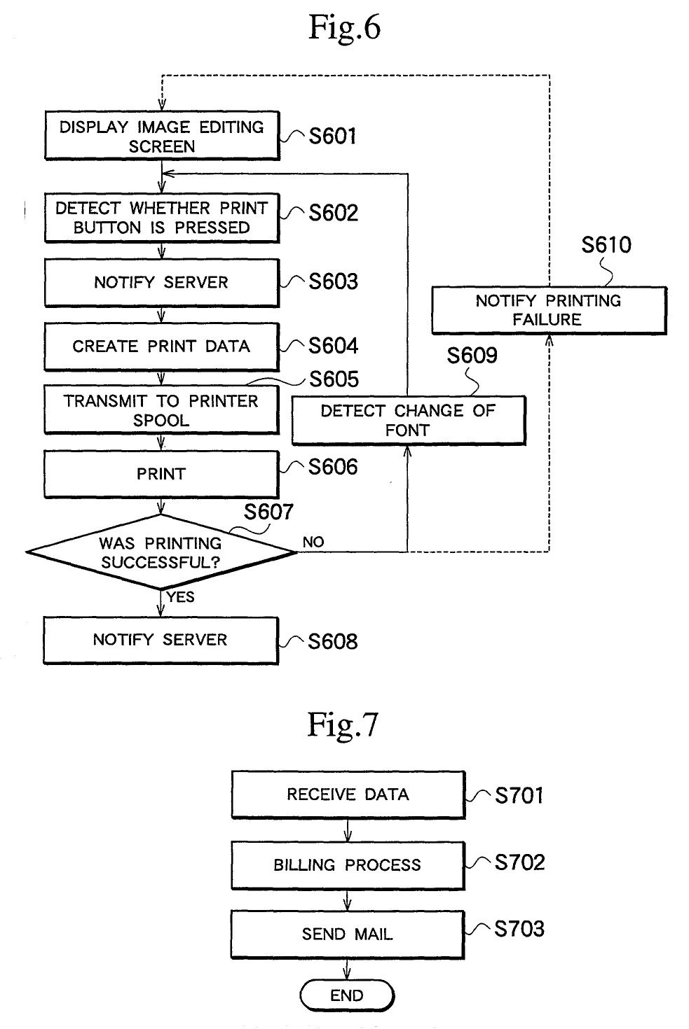

FIGS. 4 and 6 illustrate flowcharts showing the process at the communication terminal (for example, 13). FIG. 4 shows the process comprising steps S401 to 405. FIG. 6 shows the process comprising steps S601 to 610.

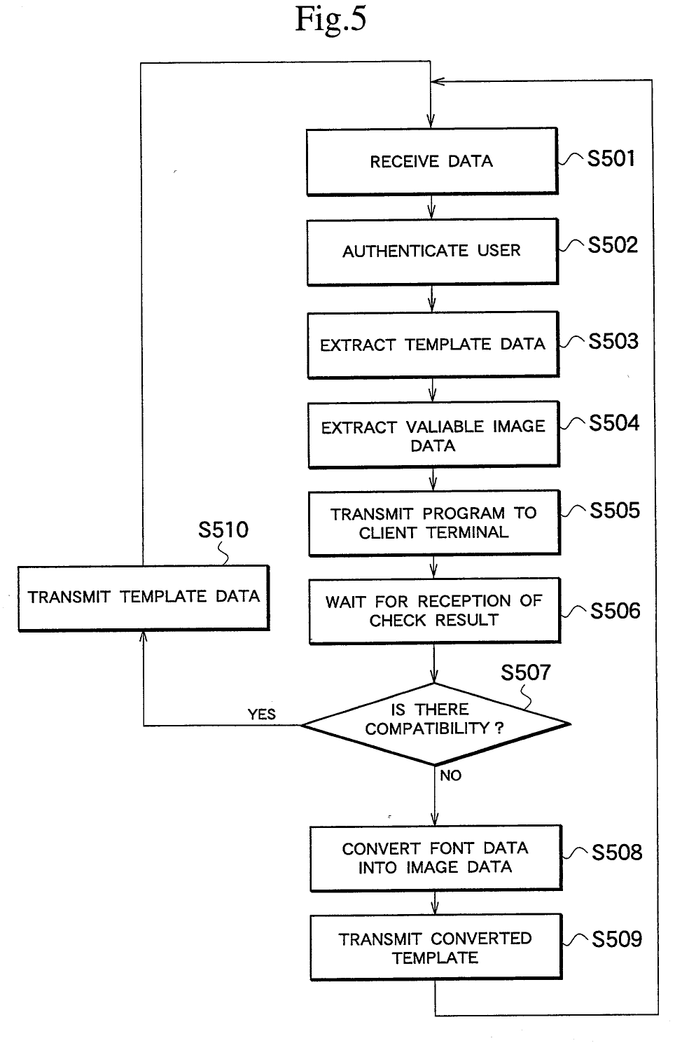

FIGS. 5 and 7 illustrate flowcharts showing the process at the Web server 12, respectively. FIG. 5 shows the process comprising steps S501 to S510. FIG. 7 shows the process comprising steps S701 to S703.

The above processes according to the present embodiment will now be described with reference to the flowcharts of FIGS. 4 to 6.

Many users, including the user U2, may simultaneously access the Web server 12. In this case, it is assumed that the user U1 communicates with the Web server 12 using the communication terminal 13 to obtain the operation supporting template TP.

When the user U1 controls the communication terminal 13 to access the Web server 12, for example, a log-in screen LP as shown in FIG. 12 is displayed on the screen of the display unit 23 in step S401 in FIG. 4. On the log-in screen LP, fields F1 to F4 for writing a user name, a password, a category, and details and a “send” button BT3 are placed.

In the fields F1 and F2, the user name and the password given to the user U1 upon member registration are inputted. In the fields F3 and F4, a category and details the user desires are inputted every time. The category means a category which an operation supporting template (for example, TP) belongs and the details denote a small classification unit included in a certain category.

When information written in the field F1 to F4 on the log-in screen LP are fixed, the user U1 presses the “send” button BT3 using the pointing device. When the Web browser 21A detects that the button is pressed (S402), the information input in the fields F1 to F4 are transmitted to the Web server 12.

After the “send” button BT3 is pressed, the communication terminal 13 enters a reception waiting state in which the terminal is waiting for a response from the Web server 12 (S403).

On the other hand, the Web server 12, which receives the information in the fields F1 to F4, retrieves the management table MT1 shown in FIG. 8 using the received information in the fields F1 and F2, thereby authenticating the user U1 (S501 and S502). At this time, when a row including a user ID matching the user ID of the field F1 and a password matching the password of the field F2 exist in the management table MT1, the authentication result denotes OK. When such a row does not exist in the table MT1, the authentication result denotes NG.

If the authentication result denotes NG, the process at the Web server 12 is stopped at that time. Alternatively, a predetermined error message can be sent to the communication terminal 13. The error message can contain a message which recommends the user to register as a member.

If the authentication result denotes OK, a process in step S503 is executed. By the process, the corresponding operation supporting template is extracted from a plurality of operation supporting templates stored in the database 40 on the basis of the information in the fields F3 and F4 received together with the information in the fields F1 and F2.

At that time, the management tables MT2 and MT3 are retrieved.

In the retrieval, the management table MT2 is first retrieved using the category written in the field F3 and the details (product name, title, and season) written in the field F4 as retrieval keys, so that an appropriate file path is obtained serving as the retrieval result. Then, the appropriate operation supporting template TP is extracted from the folder using the file path. When the management table MT2 is retrieved, an index can be obtained together with the file path. The index denotes an identifier to physically designate a location where data (in this case, a component of the operation supporting template) is stored in an indexed sequential file.

It is a matter of course that file organization (namely, physical design of database) needs not to be limited to indexed sequential organization described above.

Each font in the management table MT2 denotes a row where a value corresponding to the font name is stored. Therefore, when the management table MT2 is retrieved, the font name of the text (“Bargain!!”) P11 serving as the title of the designated operation supporting template TP can be obtained together with the file path and the index.

In this instance, since the operation supporting templates are stored separately from image data for the images P21 to P26, the corresponding image data is obtained in step S504 next to step S503.

Subsequently, the provided data creation unit 33 in the Web server 12 transmits the compatibility-check plug-in CH1 or the compatibility-check applet AP1 to the communication terminal 13 (S505). Then, the Web server waits for transmission of the check result from the plug-in CH1 or the applet AP1 (S506). When the plug-in CH1 or the applet AP1 is transmitted to the communication terminal 13, the font name obtained by retrieving the management table MT2 can be stored in the compatibility-check plug-in CH1 or the compatibility-check applet AP1.

As a result, the compatibility-check plug-in CH1 or the compatibility-check applet AP1 can check for font compatibility by comparing the font name stored therein with a font name (for example, a font name assigned to a font file in the font folder) detected in the communication terminal 13.

In the above-mentioned session management, when the check result is not transmitted after predetermined time, session can be terminated at the Web server 12.

If the communication terminal 13 is in the reception waiting state in step S403, the communication terminal 13 receives the compatibility-check plug-in CH1 or the compatibility-check applet AP1 transmitted by the Web server 12 in step S505.

Therefore, the above-mentioned response time for the user U1 corresponds to a period during which the “send” button BT3 on the log-in screen LP is pressed in step S402, the compatibility-check plug-in CH1 is received, and a screen to confirm the intention of installation is displayed on the display unit 23 (alternatively, a Web page transmitted together with the compatibility-check applet AP1 is displayed on the display unit 23).

During the period, the processing steps of steps S501 to S505 with light loads are executed at the Web server 12. Accordingly, the response time can be reduced enough.

Since the images P21 to P26 obtained in step S504 are not concerned with font compatibility, the order of the processing steps can be changed. For example, step S505 can be executed before step S504. Consequently, the response time can be further reduced.

A series of processing steps, in which the compatibility-check plug-in CH1 or the compatibility-check applet AP1 starts checking at the communication terminal 13 and the check result is transmitted to the Web server 12, can be automatically performed independently of the intention of the user U1. Alternatively, a screen to inquire of the user U1 about whether checking can be started or whether the check result can be transmitted may be displayed on the display unit 23.

If checking is finished surely in short time (for example, time enough shorter than three seconds), the inquiry is not needed. If checking may require long time (for example, eight seconds or longer), it is desirable to execute the inquiry. The reason is as follows. It is considered that, if the user U1 does not know that checking is being performed, long checking time applies stress on the user U1 in the same case as in long response time.

When checking for font compatibility by the compatibility-check plug-in CH2 or the compatibility-check applet AP1 is completed (S404), the check result is transmitted from the communication terminal 13 to the Web server 12 (S405).

When the valid check result is derived from the compatibility-check plug-in CH1 or the compatibility-check applet AP1 at the communication terminal 13 (S506), at the Web server 12, the font compatibility determination unit 35 interprets the check result and then performs the operation in accordance with the interpretation result (S507).

In other words, when the check result indicates that there is font compatibility (YES in S507), the process proceeds to step S510. The provided data creation unit 33 transmits the operation supporting template TP unmodified to the communication terminal 13 on the basis of data obtained in steps S503 and S504 (S510). When the check result indicates that there is no font compatibility (NO in S507), the process proceeds to step S508.

In step S508, the template conversion unit 34 converts the text P11, such as “Bargain!!”, serving as text data having a certain font into image data.

Subsequently, the provided data creation unit 33 reconfigures the operation supporting template TP (including no font) using the image data obtained by the conversion and then transmits the template TP to the communication terminal 13.

For the user U1, another response time corresponds to a period after the user U1 responds to the last inquiry (for example, an inquiry about confirmation of the user's intention regarding whether the check result is transmitted) of the compatibility-check plug-in CH1 or the compatibility-check applet AP1 until the operation supporting template TP is displayed on the display unit 23. During the period, the Web server 12 hardly executes the process with large load. Accordingly, the response time can be reduced enough.

In the case where the plug-in CH1 is not integrated with the plug-in CH2 or the applet AP1 is not integrated with the applet AP2, when the operation supporting template TP is transmitted in step S510 or S509, the Web server 12 also transmits the billing-check plug-in CH2 or the billing-check applet AP2.

When the screen of the operation supporting template TP as shown in FIG. 11 is displayed on the display unit 23 (S601), the user U1 performs the above-mentioned editing operation using the pointing device or keyboard provided for the operation unit 24 while viewing the screen.

After the editing operation is completed, when the user U1 presses the “print” button BT2 and the Web browser 21A detects that the button is pressed (S602), the Web browser 21A notifies the Web server 12 of the fact (S603). Simultaneously, faithful print data of the display element P1 subjected to the editing operation is created at the communication terminal 13 (S604). The print data is transmitted to a printer spool (S605) and is then printed out (S606).

If printing is normally performed, namely, if printing is successful (YES in S607), the process proceeds to step S608. The check result indicating the fact is transmitted to the Web server 12 by the function of the billing-check plug-in CH2 or the billing-check applet AP2 (S608).

In the flowchart shown by a solid line in FIG. 6, if this printing is not successful (NO in S607), the process proceeds to step S609. It is detected that the font is changed (S609). Then, the process returns to step S602 once again. The procedure corresponds to a case where the Web browser 21A which the user U1 operates has a function to change a text font on a Web page.

In other words, the user U1 changes the font of the text P11 using the function of the Web browser 21A. When the Web browser 21A detects that the font is changed, the process returns to step S602.

A loop comprising steps S602, S603, S604, S605, S606, S607, and S609 can be repeated as often as the user U1 desires.

If the Web browser 21A does not have a function to change a text font on a Web page in this manner, the procedure shown by the solid line cannot be executed. In this case, for example, as shown by a dashed line in FIG. 6, the billing-check plug-in CH2 or the billing-check applet AP2 notifies the Web server 12 of a printing failure (S610). Another operation supporting template, which is similar to the operation supporting template TP but is different therefrom with respect to the font of the text P11, may be transmitted again from the Web server 12 to the communication terminal 13. At that time, step S601 is performed subsequent to step S610, and after that, the similar processing steps can be executed repetitively.

Since repeating the processing steps increases the load on the Web server 12, a predetermined upper limit can be set to the number of transmission times of operation supporting templates TP having different fonts for the text P11.

If printing is successful at the communication terminal 13 and data indicating that printing was successful is sent to the Web server 12 in step S608, the Web server 12 receives the data (S701) as shown in FIG. 7. The billing unit 37 increases the number of successful printings in the row corresponding to the user U1 in the management table MT1 by only one to update (increase) a bill (S702).

The mail transmission unit 39 sends an e-mail indicating the increased bill to the mail address obtained from the row corresponding to the user U1 in the management table MT1 (S703).

Thus, a series of processing steps at the user U1 are completed. It is a matter of course that all of the flowcharts, including the flowchart of FIG. 7, can be performed to each user who accesses the Web server 12.

As understood from the above description, according to the present embodiment, the processing load on the Web server (12) can be efficiently lightened. Consequently, enough short response time can be realized while cost is being suppressed.

The Web server (12) according to the present embodiment can also be used as a server load balancer. Accordingly, if the server load balancer is used as necessary, the cost increases but response time can be further reduced.

In the flowchart of FIG. 6, in step S603, the Web browser 21A notifies the Web server 12 of the fact that the user U1 pressed the “print” button BT2. Step S603 can be omitted.

Furthermore, according to the present embodiment, if there is no font compatibility, the process of converting the text P11, such as “Bargain!!”, as text data having a certain font into image data is executed. In the converting process, text can be converted into text data having a certain font adapted to font compatibility instead of image data.

If checking for font compatibility is not performed and text data having a certain font (such as the text P11) is immediately converted into image data and the converted data is then provided to the communication terminal 13, steps S505 to S507 and S510 are omitted in the flowchart of FIG. 5.

What is claimed is:

1. An output supporting server which supports various outputs performed in a client terminal via a network, the server comprising:
a template storage unit for storing a template to be output, the template specifying a standard configuration of output data to be generated by the client terminal;
a template response unit for reading the output template from the template storage unit in response to a request from the client terminal and then sending the output template to the client terminal; and
an output data creation unit for creating output data after the output template is sent by the template response unit, in accordance with a configuration changing operation performed at the client terminal, the operation being performed on the output template received by the client terminal via the network, and then transmitting the created output data to the client terminal in order to permit the client terminal to generate the output data.

2. A server according to claim 1, further comprising:
a font processing capability response unit for transmitting a font processing capability checking program to the client terminal, the program having a function to check the details of font processing capability, which is a processing capability of the client terminal related to font data, and then report the check result to the output supporting server;
a compatibility determination unit for checking whether the font processing capability reported from the client terminal by the font processing capability checking program is compatible with font data of text data included in the output template; and
a template conversion unit for performing a converting process on the output template so that the text data is converted into image data accurately representing the font data when the compatibility determination unit determines that there is no compatibility, wherein
the template response unit transmits the output template after the template is subjected to the converting process by the template conversion unit to the client terminal.

3. A server according to claim 2, wherein the font processing capability response unit transmits the font processing capability checking program to the client terminal when the template response unit determines that the output template includes text data having font data.

4. A server according to claim 2, wherein
the font processing capability checking program has font identification information to identify font data of the text data included in the output template, and has a function to compare the font identification information with the font processing capability of the client terminal, determine whether the font data can be accurately processed in the client terminal, and then report the determination result to the output supporting server.

5. A server according to claim 1, wherein
the output template comprises:
a text area in which text is written in accordance with the configuration changing operation performed at the client terminal; and
an image area in which an image is placed in accordance with the configuration changing operation performed at the client terminal.

6. A server according to claim 5, wherein
the output template is accompanied by a plurality of prepared candidate images to be placed in the image area by the configuration changing operation.

7. A server according to claim 1, further comprising:
a printing-state checking program response unit for transmitting a printing-state checking program to the client terminal when the client terminal performs a print output, which is one of various possible outputs using the output data, the printing-state checking program having a function to check a processing state regarding the print output in the client terminal and then report the check result to the output supporting server.

8. A server according to claim 7, wherein
the check result report contains information indicating whether the print output in the client terminal was accomplished or failed.

9. A server according to claim 7, further comprising:
a billing unit for executing a billing process in accordance with the report of the printing-state checking program in the client terminal.

10. An output supporting system comprising:
a network;
an output supporting server; and
a client terminal, the output supporting server being connected to the client terminal via the network to communicate with each other and the output supporting system supporting various outputs performed in the client terminal through communication, wherein
the output supporting server comprises:
a template storage unit for storing a template to be output, the template specifying a standard configuration of output data to be generated by the client terminal;
a template response unit for reading the output template from the template storage unit in response to a request from the client terminal and then sending the output template to the client terminal; and
an output data creation unit for creating output data in accordance with a configuration changing operation performed at the client terminal, the operation being performed on the output template received by the client terminal via the network, and then transmitting the created output data to the client terminal in order to permit the client terminal to generate the output data, and
the client terminal comprises:
a display unit for executing screen display output for the output template, the screen display output being one of various possible outputs; and
an operation unit for receiving the configuration changing operation from a user.

11. An output supporting method for supporting various outputs performed in a client terminal via a network, the method comprising the steps of:
storing, in a template storage unit, a template to be output, the template specifying a standard configuration of output data to be generated by the client terminal;
reading, by a template response unit, the output template from the template storage unit in response to a request from the client terminal; and
creating, by an output data creation unit, the output data in accordance with a configuration changing operation performed at the client terminal, the operation being performed on the output template received by the client terminal via the network, and then transmitting the output data in order to permit the client terminal to generate the output data.

12. A method according to claim 11, further comprising the steps of:
transmitting, by a font processing capability response unit, a font processing capability checking program to the client terminal, the program having a function to check the details of font processing capability, which is a processing capability of the client terminal related to font data, and then report the check result to the output supporting server;
determining, by a compatibility determination unit, whether the font processing capability reported from the client terminal by the font processing capability checking program is compatible with font data of text data included in the output template; and
converting, by a template conversion unit, the output template so that the text data is converted into image data accurately representing the font data when there is no compatibility, wherein
the template response unit transmits the output template after the template is subjected to the conversion by the template conversion unit to the client terminal.

13. A method according to claim 11, wherein
the output template comprises:
a text area in which text is written in accordance with the configuration changing operation performed at the client terminal; and
an image area in which an image is placed in accordance with the configuration changing operation performed at the client terminal.

14. A method according to claim 13, wherein
the output template is accompanied by a plurality of prepared candidate images to be placed in the image area by the configuration changing operation.

15. A method according claim 11, further comprising the step of:
transmitting, by a printing-state checking program response unit, a printing-state checking program to the client terminal when a print output, which is one of the various possible outputs, is performed using the output data in the client terminal, the program having a function to check a processing state regarding the print output in the client terminal and then report the check result to the output supporting server.

16. A method according to claim 15, wherein the check result report contains at least information indicating whether the print output in the client terminal was accomplished or failed.

17. A method according to claim 15, further comprising the step of:
executing, by a billing unit, a billing process in accordance with the report made by the printing-state checking program in the client terminal.
